(19) United States
(12) Patent Application Publication
(10) Pub. No.: US 2001/0041851 A1
(43) Pub. Date: Nov. 15, 2001

(54) Device for treatment of headache and cranio-cervical pain

(76) Inventors: Ronald G. Peyton, Alpharetta, GA (US); John C. Evans, Atlanta, GA (US)

Correspondence Address: Ira S. Dorman, 330 Roberts Street, Suite 200, East Hartford, CT, 06108, US

(21) Appl. No.: 09/775,418

(22) Filed: Feb. 1, 2001

Related U.S. Application Data
(60) Provisional application No. 60/180,932, filed on Feb. 8, 2000.

(51) Int. Cl. A61H 7/00

(52) U.S. Cl. 601/133; 601/134

(57) ABSTRACT

A device for relieving headache and other cranio-cervical pain, through the application of static occipital accupressure, consists of a pair of posts projecting from a supporting housing. The posts are laterally adjustable, for varying their mutual spacing, and they are fitted with contact elements of selectively differing hardness for control of the character and magnitude of the pressure applied.

### CROSS REFERENCE TO PROVISIONAL APPLICATION

This application claims the benefit of provisional application No. 60/180,932, filed Feb.8, 2000 in the names of the present inventors and bearing the title hereof.

### BACKGROUND OF THE INVENTION

It has been stated authoritatively that headache is among the most common of the pain complaints made by patients seen in primary-care doctors' offices, but that, if treated correctly, more than 85 percent of headaches will respond. There are at present devices on the market that claim to massage, manipulate, or use accupressure for the treatment of certain ailments. None of these devices is however believed to focus upon, or to provide an effective treatment system for, headaches; and as far as is known, means has not heretofore been available for readily applying static occipital accupressure, at the appropriate trigger points and for extended periods of time, for the alleviation of headache and/or cranio-cervical pain.

### SUMMARY OF THE INVENTION

It is the primary object of the present invention to provide a novel device for the treatment of headache and cranio-cervical pain.

More specific objects are to provide such a device by which static occipital accupressure can be applied effectively at appropriate trigger points, which device is convenient to use and is of incomplex and relatively inexpensive construction and manufacture.

It has now been found that the foregoing and related objects of the invention are attained by the provision of a device for treatment of headache and cranio-cervical pain, through static occipital stimulation, comprising a base and a pair of contact members upstanding on the base. Each contact member has an upper end portion comprising a pressure element, the pressure elements being mutually spaced to enable bilateral contact thereby upon the occipital area of an individual. Generally, at least one of the contact members, and preferably both, will be movable on the base for varying the mutual spacing of the pressure elements.

In a specific form of the device the base includes structure defining a slot, in which slot an engagement portion one or both of the contact members is slidably received for guiding such movement thereof, for spacing variation. The slotted base structure may have an upper surface and a lower surface, and the engagement portion of the contact member may include at least one upper and at least one lower transverse engagement element disposed, respectively, above and below the slotted base structure. In such an embodiment the contact member will be generally rotatable, or pivotable, in a first direction, so as to bring the upper and lower transverse elements thereof into concurrent engagement with the upper and lower surfaces of the slotted structure, respectively, so as to thereby maintain the contact member in a selected position along the length of the slot; such engagement will generally be effected merely by the force of the head of an individual disposed upon the device for treatment. Pivoting the contact member in the opposite direction will disengage the transverse elements to facilitate displacement of the contact member along the slot.

In the preferred embodiments, the upper end portion of each contact member will comprise a post portion, and a contact component disengageably mounted on the post portion will provide the pressure element thereon; typically, the contact component will take the form of a generally spherical attachment. Most desirably, the device will include at least two pairs of such contact components alternatively mountable on the post portions, the contact components of one pair having at least one pressure-applying feature that is different from the components of the pair; in most instances the pressure-applying feature will be the hardness value of the contact component.

The device of the invention functions to treat headache and cranio-cervical pain through the use of static occipital accupressure, and it is engineered to apply such pressure in a systematic and progressive manner. For reasons that are well-established in the scientific literature, gentle pressure of the skin can be profoundly effective in relieving pain; the effects induced include warming and softening of previously tightened structures. The device can be used independently or, for maximum effect, in combination with other traditional treatments. It is suitable for use by the medical community, including physicians, physical therapists, psychologists, chiropractors, athletic trainers, massage therapists, nurses and other healthcare practitioners; it is also suitable for self-administration by the subject.

In use, the individual to be treated lies or sits in a supine or reclined position, and places the device behind his head with the accupressure contact elements located directly over the trigger points at the base of his skull (occipital area), thereby enabling him to receive static occipital stimulation. The individual may be instructed to lie on the device for 20 minutes or so, while listening to relaxation music; typically, he might do so three time daily if the headache or other pain persists, but in many instances a single session will suffice. Treatment may advantageously be administered as a gradual process.

The contact components (described more fully below) desirably take the form of pressure balls that are color-coded to indicate a degree of softness or hardness (i.e., Durometer value) of the material from which they are fabricated. For example, each of three pairs of interchangeable pressure balls, ranging in character from soft and resilient to hard and firm, may be employed. The contact components are advantageously supported by a pair of pivot arms, which are disposed to fit comfortably under the subject's head in contact with the pressure points; normally, the mutual spacing of the pivot arms will be readily adjustable to best accommodate differences in head size as well as to enable variation of the amount of cervical flexion produced. Initial treatment will typically employ relatively soft balls, with elements of increasing Durometer being substituted to produce firmer pressure as the individual adapts; ultimate benefit will usually be realized with accupressure delivered from balls having the highest hardness level.

### BRIEF DESCRIPTION OF THE DRAWINGS

FIG. 1 is a diagrammatical side elevational view showing the device of the invention in use for applying static occipital accupressure at the base of the skull of an individual;

FIG. 2 is diagrammatical illustration similar to FIG. 1, taken so as to view the top of the subject's head;

FIG. 3 is a top plan view of the device of the invention, with the pressure balls removed;

FIGS. 4 and 5 are sectional views of the device, both taken along line 4/5 of FIG. 3, showing the pivot arms in various positions and, in the case of FIG. 4, showing the pressure balls removed;

FIG. 6 is a partially exploded sectional view of the device, taken along line 6-6 of FIG. 3;

FIG. 7 is a perspective, partially exploded view of one of the pivot arm assemblies utilized in the device; and

FIG. 8 is an end view of the device showing the pressure balls in place and also showing two alternative forms of pressure-delivering elements.

### DETAILED DESCRIPTION OF THE PREFERRED AND ILLUSTRATED EMBODIMENTS

In the illustrated embodiment, the device of the invention consists of an open-back housing, generally designated by the numeral 10, which will desirably be of molded plastic construction and symmetrical about two perpendicular axes. Shoulder portions of the housing 12 incline arcuately to top wall portions 14, and downwardly concave wall portions 15 cooperatively define a slight depression extending transversely across the housing. A sidewall portion 16, depending from the top wall portions 14 and the concave wall portions 15, defines an upwardly opening rectangular channel 18, from the opposite sides of which elongate flange elements 20 extend laterally along most of its length to cooperatively provide a supporting platform, longitudinally slotted from its opposite ends at 22. Indented structures 24 at the ends of the housing 10 define narrow openings 26 through which a strap 28 may be received for mounting the device to a reclining chair or the like, and four rubber feet 30 are engaged in downwardly opening sockets formed at the corners of the housing.

Each of a pair of pivot arm assemblies, generally designated by the numeral 40, consists of a circular base 42, a knobbed post 44 projecting upwardly from the center of the base, and a downwardly extending web portion 46. A pair of cylindrical boss elements 48 project transversely from opposite sides of the web portion 46, at its lower end, and a pair of ear elements 50 project similarly at a somewhat higher level and in a laterally offset relationship thereto. A rubber insert 52 is seated within each of the ear elements 50, and a retaining flange 54 extends along each side of the web 46, perpendicular thereto and to the base 42; the flanges serve to prevent the arm assembly form dropping downwardly, when no pressure is applied.

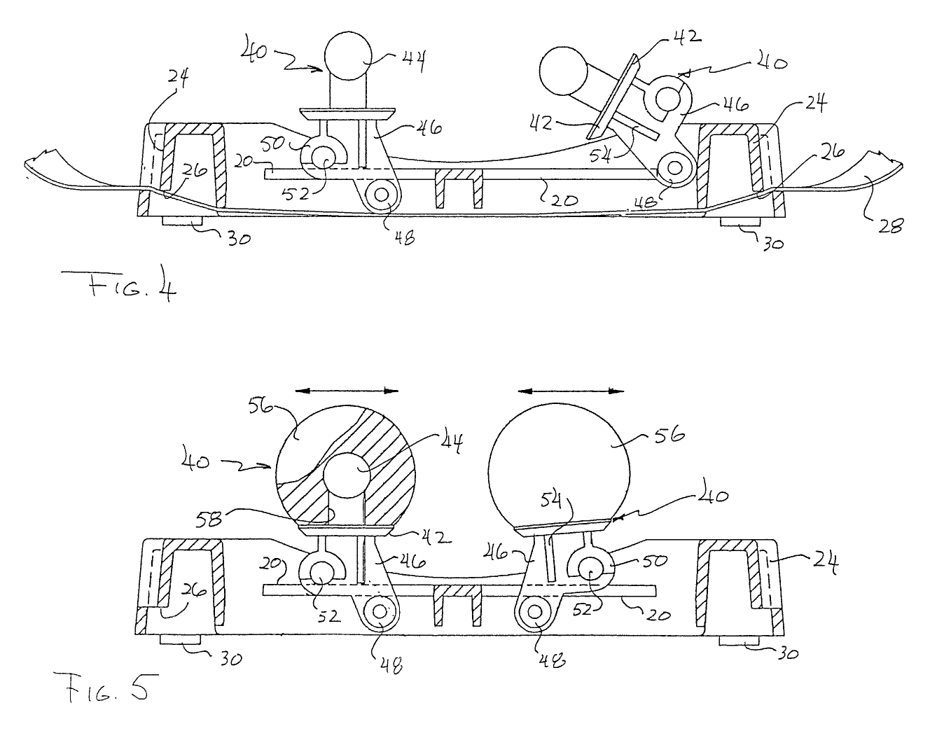

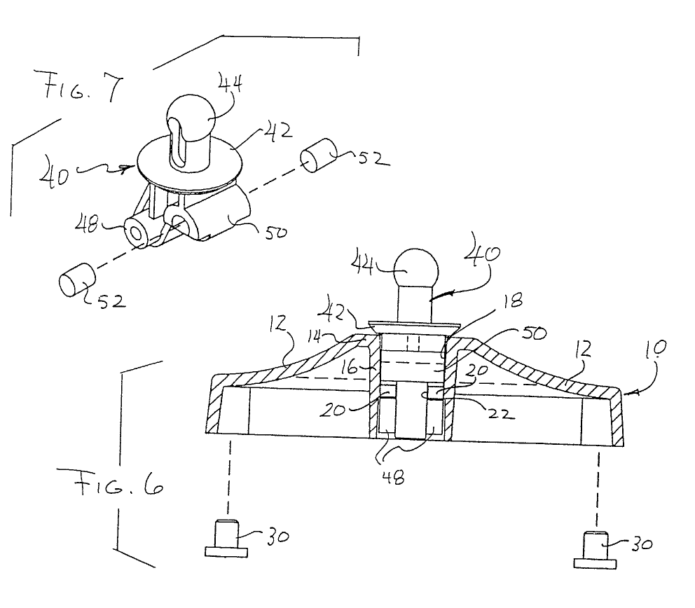

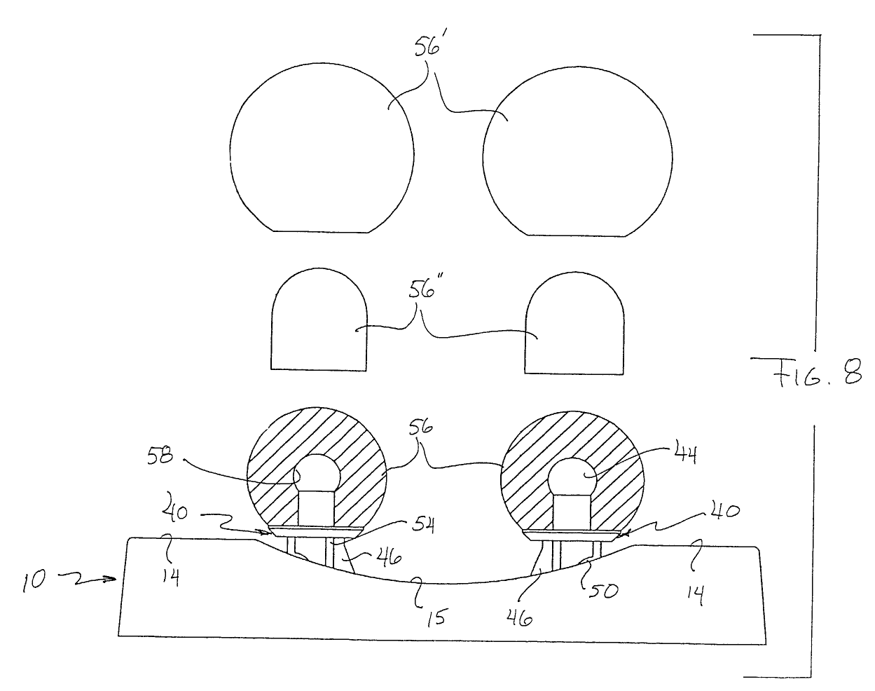

As is best seen in FIG. 4, the pivot arm assemblies 40 are installed by aligning the lower support boss elements 48 over the space defined at either end of the platform provided by flanges 20, with the arm appropriately tilted (as shown at the right of the figure) to enable insertion. Engagement is of course effected by rotation of the arm to a more upright orientation so as to bring the boss elements 48 and the inserts 52 into contact with the lower and upper surfaces of the flanges 20, respectively, and one or both of those surfaces may be roughened or textured to increase friction and prevent slippage, if so desired. Repositioning of the arm assembly is achieved simply by tilting it slightly, such as to the attitude shown at the right of FIG. 5, thereby relieving the opposing forces and allowing it to slide readily along the supporting platform; scales 57 are desirably provided along the channel 18 to facilitate positioning.

A ball, or contact component, 56 is mounted upon the knobbed post 44 of each arm assembly 40, each ball being formed with a suitable opening 58 for that purpose; the fully engaged ball 56 is seated upon the base 42. The contact components will usually be made of a rubbery material but, as discussed above, the composition and/or formulation thereof may vary as necessary to provide the desired physical characteristics. As illustrated by FIG. 8, moreover, the size and form of the component may vary widely; the ball 56′ is of larger diameter than the ball 56, and a smaller, somewhat cylindrical element is shown at 56′.

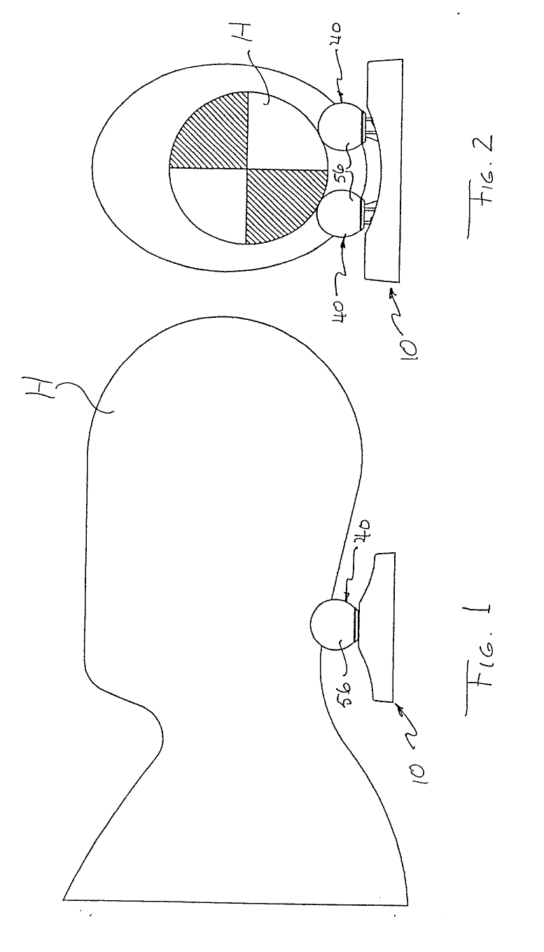

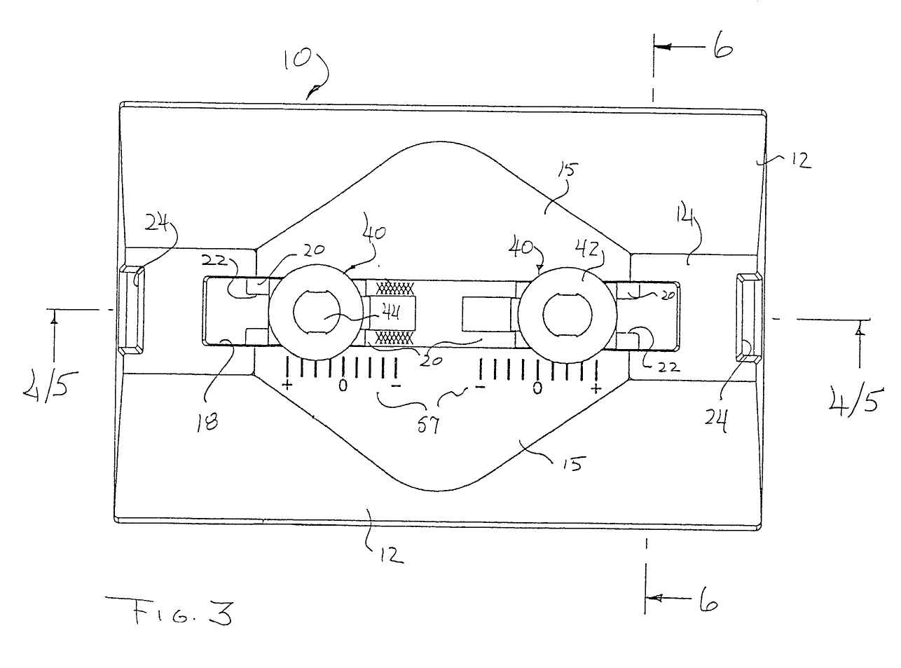

In use, pressure elements (e.g., contacting portions of contact components) apply accupressure to trigger points at the base of the skull, as suggested by the depiction of the human head H in FIGS. 1 and 2.

Many changes from, and variations in, the described embodiment and the features thereof will of course occur to those skilled in the art, and can be made without departure from the concepts of the present invention.

Thus, it can be seen that the present invention provides a novel device for the treatment of headache and cranio-cervical pain. More specifically, the invention provides such a device by which static occipital accupressure can be applied effectively at appropriate trigger points, which device is convenient to use and is of incomplex and relatively inexpensive construction and manufacture.

Having thus described the invention, what is claimed is:

1. A device for treatment of headache and cranio-cervical pain, through static occipital stimulation, comprising a base and a pair of contact members upstanding on said base, each of said contact members having an upper end portion comprising a pressure element, said pressure elements being mutually spaced to enable bilateral contact thereby upon the occipital area of an individual, and said contact members being movable on said base for varying the mutual spacing of said pressure elements.

2. The device of claim 1 wherein said base includes structure defining a slot, and wherein each of said contact members has an engagement portion slidably received in said slot for guiding such movement thereof for spacing variation.

3. The device of claim 2 wherein said slotted base structure has an upper surface and a lower surface, and wherein said engagement portion of said each contact member includes at least one upper transverse engagement element and at least one lower transverse engagement element disposed, respectively, above and below said slotted base structure, said contact member being generally rotatable in a first direction so as to bring said upper and lower transverse elements into concurrent engagement with said upper and lower surfaces of said slotted structure, respectively, for maintaining said contact member in a selected position along the length of said slot, and said contact member being generally rotatable in the opposite direction for disengagement of said transverse elements from said surfaces for facilitating displacement of said contact member along said slot.

4. The device of claim 3 wherein said contact member is so constructed that said transverse elements are urged into such concurrent engagement by the force of the head of an individual disposed upon said device for such treatment.

5. The device of claim 2 wherein said base additionally includes distance scale means for facilitating selective positioning of said contact members along said slot.

6. The device of claim 1 wherein said upper end portion of each of said contact members comprises a post portion, and wherein a contact component, disengageably mounted on said post portion, provides said pressure element thereon.

7. The device of claim 6 including at least first and second pairs of said contact components alternatively mountable on said post portions, said contact components of said first pair having at least one pressure-applying feature different from said contact components of said second pair.

8. The device of claim 7 wherein said pressure-applying feature is hardness value.

9. The device of claim 7 wherein said contact components are generally spherical attachments.

10. A device for treatment of headache and cranio-cervical pain, through static occipital stimulation, comprising a base and a pair of contact members upstanding on said base, each of said contact members having an upper end portion comprising a pressure element, said pressure elements being mutually spaced to enable bilateral contact thereby upon the occipital area of an individual.

11. The device of claim 10 wherein at least one of said contact members is movable on said base for varying the mutual spacing of said pressure elements.

12. The device of claim 11 wherein said base includes structure defining a slot, and wherein said at least one contact member has an engagement portion slidably received in said slot for guiding such movement thereof for spacing variation.

13. The device of claim 12 wherein said slotted base structure has an upper surface and a lower surface, and wherein said engagement portion of said at least one contact member includes at least one upper transverse engagement element and at least one lower transverse engagement element disposed, respectively, above and below said slotted base structure, said one contact member being generally rotatable in a first direction so as to bring said upper and lower transverse engagement elements of said engagement portion into concurrent engagement with said upper and lower surfaces of said slotted structure, respectively, for maintaining said one contact member in a selected position along the length of said slot, and said contact member being generally rotatable in the opposite direction for disengagement of said transverse elements from said surfaces for facilitating displacement of said contact member along said slot.

14. The device of claim 13 wherein said one contact member is so constructed that said transverse elements are urged into such concurrent engagement by the force of the head of an individual disposed upon said device for such treatment.

15. The device of claim 11 wherein both of said contact members are so movable on said base.

16. The device of claim 11 wherein said base additionally includes distance scale means for facilitating selective positioning of said at least one contact member along said slot.

17. The device of claim 10 wherein said upper end portion of each of said contact members comprises a post portion, and wherein a contact component, disengageably mounted on said post portion, provides said pressure element thereon.

18. The device of claim 17 including at least first and second pairs of said contact components alternatively mountable on said post portions, said contact components of said first pair having at least one pressure-applying feature different from said contact components of said second pair.

19. The device of claim 18 wherein said pressure-applying feature is hardness value.

20. The device of claim 18 wherein said contact components are generally spherical attachments.
